(19) United States
(12) Patent Application Publication
(10) Pub. No.: US 2021/0196995 A1
(43) Pub. Date: Jul. 1, 2021

(54) SUSPENSION CABLE WALL ANCHORING DEVICE

(71) Applicant: Frishman Bros Ltd, Hefer Valley Regional Council (IL)

(72) Inventor: Zeev Frishman, Hefer Valley Regional Council (IL)

(21) Appl. No.: 16/078,021

(22) PCT Filed: Apr. 16, 2018
(86) PCT No.: PCT/IL2018/050423

§ 371 Date: Aug. 21, 2018

(30) Foreign Application Priority Data
Apr. 24, 2017 (IL) 251878

(51) Int. Cl. A62B 35/00; E04G 21/32

(52) U.S. Cl. CPC A62B 35/0068; E04G 21/3276

(57) ABSTRACT

A device comprising an angular body including a horizontal arm and a vertical arm configured for being positioned perpendicularly to one another and having an overlapping portion, the horizontal arm comprising a horizontal engagement platform; the vertical arm comprising a vertical engagement platform; the angular body further comprising an aperture adapted to accommodate a suspension cable; and, a width adjusting member.

In some embodiments, the horizontal engagement platform extending along the horizontal arm from an end opposing the overlapping portion to a point spaced from the vertical arm. Additionally or alternatively, the vertical engagement platform extending along the vertical arm from an end opposing the overlapping portion to a point spaced from the horizontal arm.

### CROSS-REFERENCE TO RELATED APPLICATIONS

This application claims the benefit of priority from Israel Patent Application No. 251,878 filed Apr. 24, 2017, titled “SUSPENSION CABLE WALL ANCHORING DEVICE”, which is hereby incorporated herein by reference in its entirety without giving rise to disavowment.

### TECHNICAL FIELD

The present disclosure relates to securing equipment in general, and to a device for anchoring a suspension cable to a wall, in particular.

### BACKGROUND

Modern day urban architecture is characterized in high rise structures, especially in large metropolitan areas where apartment buildings and office towers may rise up to tens of stories high. While these structures provide economic and technical benefits in areas of high population concentrations and have become a landmark of developed regions around the globe, there are also myriad challenges involved in their construction, as well as in maintenance or inspection thereof.

One such challenge is a need of manual labor or action to be performed for which humans may be required to climb to great heights, thus risking in grave injury or even death in case of inadvertently tripping and falling down. Appropriate safety measures for preventing loss of lives and mitigating harms to staff workers due to accidental free fall, such as usage of harnesses, slings, lanyards, cords, strings, wires, and similar securing means for fall restraint or fall arrest, thus have to be taken.

One technique in widespread use, referred to as “rappelling” or “abseiling”, allows for a controlled descent of a vertical drop, such as a face of a cliff or an upright structure, using a rope. Initially used for climbing and caving, the technique has later evolved to a work positioning form known as “rope access”, where technicians access difficult-to-reach areas from above. Rappelling has a wide variety of industrial applications, as well as recreational, rescue or military ones.

### BRIEF SUMMARY

One exemplary embodiment of the disclosed subject matter is a device comprising: an angular body comprising a horizontal arm and a vertical arm configured for being positioned perpendicularly to one another and connected at an overlapping portion therebetween, wherein: the horizontal arm comprising a horizontal engagement platform to be mounted on a top portion of a wall erected uprightly, the horizontal engagement platform extending along the horizontal arm from an end opposing the overlapping portion to a point spaced from the vertical arm, whereby a cavity between the horizontal arm and the top portion of the wall is formed; the vertical arm comprising a vertical engagement platform to be adjoined to a front face portion of the wall; the angular body further comprising an aperture adapted to accommodate a suspension cable; and, a width adjusting member capable of being fixated to the horizontal arm at one of a plurality of predetermined locations, the width adjusting member being further configured to accommodate a clamping member having an opposing engagement plate substantially parallel to the vertical engagement platform and adapted to be adjoined to a rear face portion of the wall, the opposing engagement plate being selectively movable towards and away from the rear face portion to allow for selective fastening and unfastening of the device to the wall.

Optionally, the aperture in the angular body is located at an upper portion of the vertical arm proximally to the overlapping portion.

Optionally, the aperture in the angular body is located at an end of the horizontal arm protruding beyond the overlapping portion.

Optionally, the aperture in the angular body is located at the overlapping portion.

Optionally, the width adjusting member is positioned in an angle of less than 90 degrees relatively to the horizontal arm.

Optionally, the width adjusting member further comprises a support member of a triangular shape configured for engagement with the horizontal engagement platform at a point where the width adjusting member is fixated to the horizontal arm.

Optionally, the horizontal arm comprises a plurality of apertures disposed along a longitudinal axis thereof and configured to accommodate a laterally inserted bolt, wherein the plurality of predetermined locations at which the width adjusting member is capable of being fixated to the horizontal arm are congruent with the positions of the plurality of apertures.

Optionally, the clamping member comprises a screwable threaded rod to which the opposing engagement plate is connected at one end and having a gripping handle provided at another end.

Optionally, the vertical engagement platform extending along the vertical arm from an end opposing the overlapping portion to a point spaced from the horizontal arm, whereby a cavity between the vertical arm and the front face portion of the wall is formed.

Another exemplary embodiment of the disclosed subject matter is a device comprising: an angular body comprising a horizontal arm and a vertical arm configured for being positioned perpendicularly to one another and connected at an overlapping portion therebetween, wherein: the horizontal arm comprising a horizontal engagement platform to be mounted on a top portion of a wall erected uprightly; the vertical arm comprising a vertical engagement platform to be adjoined to a front face portion of the wall, the vertical engagement platform extending along the vertical arm from an end opposing the overlapping portion to a point spaced from the horizontal arm, whereby a cavity between the vertical arm and the front face portion of the wall is formed; the angular body further comprising an aperture adapted to accommodate a suspension cable; and, a width adjusting member capable of being fixated to the horizontal arm at one of a plurality of predetermined locations, the width adjusting member being further configured to accommodate a clamping member having an opposing engagement plate substantially parallel to the vertical engagement platform and adapted to be adjoined to a rear face portion of the wall, the opposing engagement plate being selectively movable towards and away from the rear face portion to allow for selective fastening and unfastening of the device to the wall.

Optionally, the aperture in the angular body is located at an upper portion of the vertical arm proximally to the overlapping portion.

Optionally, the aperture in the angular body is located at an end of the horizontal arm protruding beyond the overlapping portion.

Optionally, the aperture in the angular body is located at the overlapping portion.

Optionally, the width adjusting member is positioned in an angle of less than 90 degrees relatively to the horizontal arm.

Optionally, the width adjusting member further comprises a support member of a triangular shape configured for engagement with the horizontal engagement platform at a point where the width adjusting member is fixated to the horizontal arm.

Optionally, the horizontal arm comprises a plurality of apertures disposed along a longitudinal axis thereof and configured to accommodate a laterally inserted bolt, wherein the plurality of predetermined locations at which the width adjusting member is capable of being fixated to the horizontal arm are congruent with the positions of the plurality of apertures.

Optionally, the clamping member comprises a screwable threaded rod to which the opposing engagement plate is connected at one end and having a gripping handle provided at another end.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIGS. 1A-1C show schematic illustrations of an anchoring device, in accordance with some exemplary embodiments of the disclosed subject matter.

### DETAILED DESCRIPTION

One technical problem dealt with by the disclosed subject matter is to provide a means for anchoring a suspension cable to a wall. Another technical problem dealt with by the disclosed subject matter is to provide an anchoring means capable of accommodating a wall of an arbitrary width. Yet another technical problem dealt with by the disclosed subject matter is to provide an anchoring means that can be utilized without damaging features of the wall, such as cornices, eaves, or the like.

One technical solution is to provide an anchoring device comprising two orthogonal arms having contact surfaces for positioning against a front face of a wall and on top of an upper edge thereof, respectively, and an opposite contact surface attached to a width adjusting means and configured to be tightly fastened to a rear face of the wall in a location opposing the arm being in contact with the front face. The width adjusting means may be configured to connect to the arm being mounted on top of the wall at any one of a plurality of predetermined locations. The width adjusting means may be tilted towards the arm in a less than right angle, for enhancing traction of the device in its clamping operation on the wall.

In some exemplary embodiments, one or both of the contact surfaces may extend along the arms only in part, such that at least a portion of the arms near a region where the two coincide is inwardly removed from the outer edges of the wall and does not directly engage them. In some exemplary embodiments, a support member of a triangular form may be provided between the width adjusting member and the contact surface engaging the top of the wall, such that displacement of the width adjusting means in an upwards circular movement is prevented.

In some exemplary embodiments, the arms may be connected to one another by a hinge. One or more bolts may be utilized to fixate the arms perpendicularly to one another. The horizontal arm to be placed on top may comprise a plurality of apertures, such that the width adjusting means may be fixated at each of which using a bolt of a suitable size and shape. Additionally or alternatively, the width adjusting means may be configured to selectively and securely moved along the horizontal arm along a threaded rod.

In some exemplary embodiments, the opposite contact surface may be attached to the width adjusting means via a threaded element, such as a rod, to allow either fastening or unfastening thereof when being screwed inwards or outwards, respectively. The threaded element may be provided with a handle for facilitating operation thereof.

In some exemplary embodiments, an aperture configured for receiving a suspension cord, a rope, a cable hook, a shackle, a carabiner or the like may be provided in at least one of the arms. The aperture may be located in a position either at an area of overlap between the two arms or in a vicinity thereof, such that an anchorage point for attaching a suspension cable thereto thus provided is at a similar height as the top edge of the wall.

One technical effect of utilizing the disclosed subject matter is to provide an anchoring means that is portable and can be readily and easily installed on site and taken apart after use. Another technical effect of utilizing the disclosed subject matter is to provide an anchoring means that can be fitted to various walls differing in width or finishing while preserving such structural features intact. Yet another technical effect of utilizing the disclosed subject matter is to provide an anchoring means having an attachment point for connecting a suspension cable that is collocated with the whereabouts of the top edge of the wall, thereby shortening a distance from the top edge that a person harnessed to the anchoring means is required to travel down to enter into a rappelling position at an initial location of a descent or traverse course. It will be appreciated that transitioning or jumping to rappelling position from normal standing pose may often be experienced as discomforting or frightening, thus decreasing the fall distance can ease an unpleasantness of this sort. Yet another technical effect may be providing secure attachment point using an overlap of the two arms, thereby increasing the depth of the aperture used for the anchoring point, decreasing the possibility of a failure due to physical forces applied thereon.

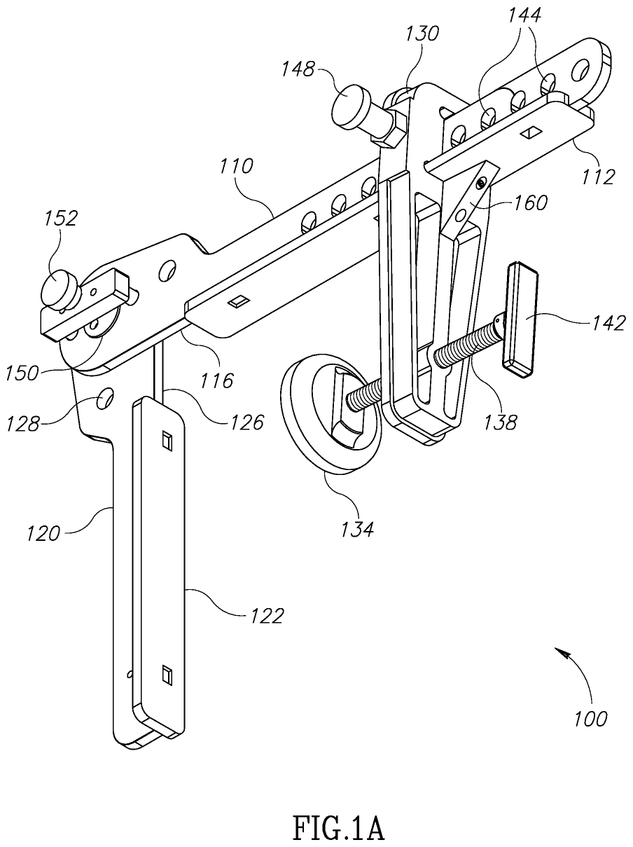

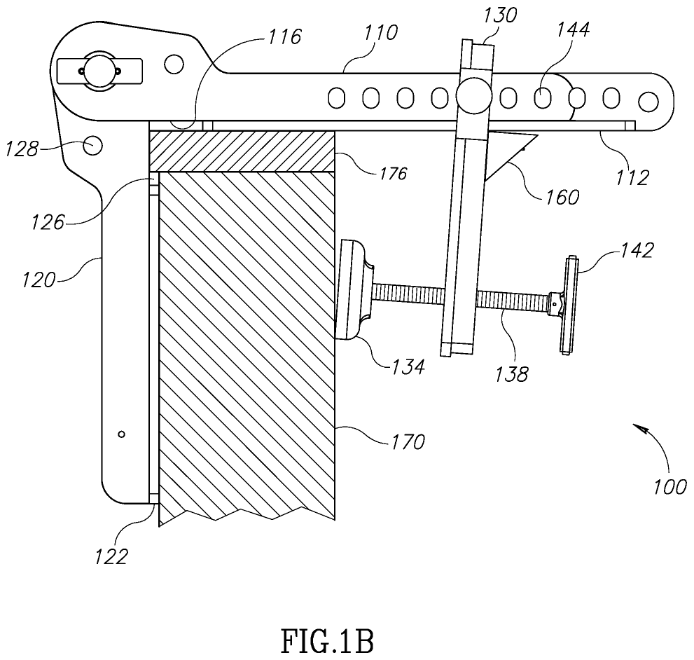

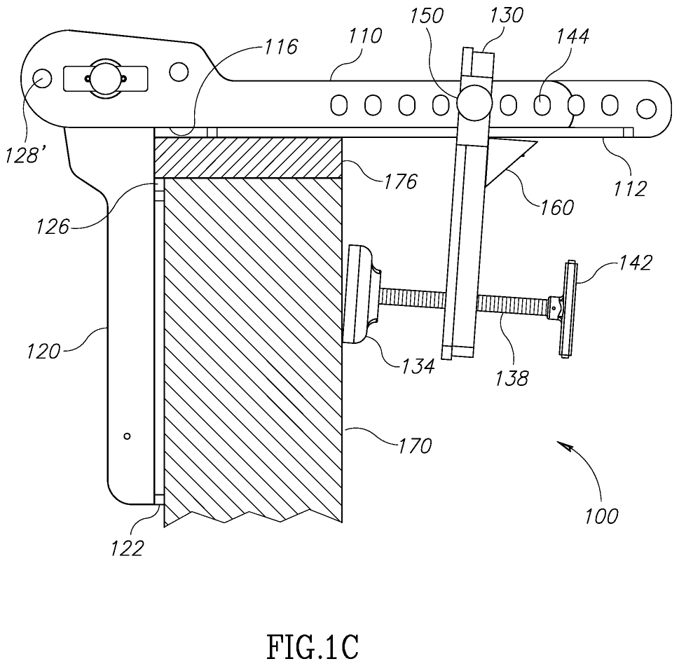

Referring now to FIG. 1A showing a schematic illustration of an anchoring device, in accordance with some exemplary embodiments of the disclosed subject matter.

An Anchoring Device 100 may comprise an Arm 110 having a Platform 112 extending along one side thereof. Arm 110 may be connected to an Arm 120 and configured for being disposed perpendicularly thereto. Arm 120 may similarly comprise a Platform 122 extending along a side thereof facing Platform 112. Platform 112 may end at a Recess 116 near a region of Arm 110 overlapping with Arm 120. Similarly, Platform 122 may end at a Recess 126 near a region of Arm 120 overlapping with Arm 110. Arm 120 may comprise an Aperture 128 adapted to accommodate a suspension cable or a suitable attachment means thereof, e.g. a ring, a hook, a carabiner, or the like.

Anchoring Device 100 may further comprise a Width Adjuster 130. Width Adjuster 130 may comprise a Platform 134 facing Platform 122. Platform 134 may be positioned in an orientation substantially parallel to Platform 122. Platform 134 may be positioned in an orientation substantially perpendicular to Platform 112. Width Adjuster 130 may comprise a threaded Rod 138 connected to Platform 134 at one end thereof. Platform 134 may be moved in a substantially continuous manner at a direction towards or away from Platform 122 by rotating Rod 138 around its axis in a screwing in or screwing out operation, respectively. Rod 138 may further be connected to a Handle 142 at the other end thereof opposite to Platform 134, for facilitating manipulation of Platform 134 via Rod 138.

Width Adjuster 130 may be configured for fixating to Arm 110 at any one of a plurality of predetermined locations. In some exemplary embodiments, Arm 110 may comprise a plurality of Apertures 144 at each of which Width Adjuster 130 may be firmly secured, utilizing for example a Bolt 148 or the like. Width Adjuster 130 may be configured in size and shape to encompass Arm 110 and Platform 112, such that Width Adjuster 130 can be assembled onto Arm 110 or removed therefrom.

In some exemplary embodiments, Arms 110 and 120 may be connected to one another by a Hinge 150 to allow folding of Arms 110 and 120 together in a more compact form, such that Device 100 can be conveniently carried or stored. Arms 110 and 120 may be fixated either in a folded or unfolded state using an appropriate securing means such as a Bolt 152, wherein in unfolded state Arms 110 and 120 are orthogonal to one another while in folded state they are substantially collinear.

In some exemplary embodiments, Device 100 may further comprise a Reinforcer 160 attached to Width Adjuster 130 at a location adjacent to Platform 112. Reinforcer 160 may provide additional support to Width Adjuster 130 during clamping operation of Device 100 in which Platform 122 being pressed against one side of a wall while Platform 134 being fastened tightly to the other side of the wall. In some exemplary embodiments, Reinforcer 160 may have two substantially perpendicular walls, one wall supporting Platform 112, and another wall supporting Width Adjuster 130. In some exemplary embodiments, Reinforcer 160 may have a shape of a right triangle.

Referring now to FIG. 1B showing a schematic illustration of an anchoring device, in accordance with some exemplary embodiments of the disclosed subject matter.

Device 100 is illustrated in FIG. 1B during installation onto a Wall 170. In some exemplary embodiments, Wall 170 may have a Coping 176 at the top end thereof. Arm 110 may be horizontally mounted on top of Wall 170, with Platform 112 directly contacting the top edge of Wall 170, such as the upper surface of Coping 176, as illustrated herein. Arm 120 may be vertically positioned adjacent to a surface of Wall 170 facing outwardly, with Platform 122 directly contacting the surface. Arm 120 may comprise an Aperture 128 for attaching a suspension cable or rope thereto.

It will be appreciated that due to Recess 116 in Arm 110, at least a portion of Coping 176 is left uncontacted by Arm 110 and Platform 112. Similarly, due to Recess 126, a portion of Coping 176 is also left uncontacted by Arm 120 and Platform 122, such that the outwardly facing slight protrusion feature of Coping 176 remains unharmed while Device 100 is utilized. Width Adjuster 130 may be fixated to Arm 110 using one of Apertures 144. Platform 134 may be positioned adjacent to an opposite surface of Wall 170 opposing the surface contacted by Platform 122. Platform 134 may be selectively fastened or unfastened to Wall 170 by rotating Rod 138 in a screwing in or screwing out motion, respectively, utilizing Handle 142. It will be appreciated that Width Adjuster 130 may be tilted towards Arm 110 in a less than right angle (e.g., about 89 degrees, about 85 degrees, about 80 degrees, or the like), such that an acute angle may be formed between Platform 134 and Wall 170, as well as between Reinforcer 160 and Platform 112. Width Adjuster 130 may be configured, while Device 100 being tightly secured to Wall 170, to slightly and gradually rotate in an opposite direction in response to the pressure applied on Platform 134 and Rod 138 by Wall 170, such that a gap between Platform 134 and Wall 170, and similarly a gap between Reinforcer 160 and Platform 112, may be closed eventually to provide a secure anchoring for a suspension rope or cable.

Referring now to FIG. 1C showing a schematic illustration of an anchoring device, in accordance with some exemplary embodiments of the disclosed subject matter.

Device 100 is illustrated in FIG. 1C during installation onto a Wall 170 having a Coping 176, similarly as in FIG. 1B. Arm 110 may be slightly elongated to extend further past a region of overlap with Arm 120, such that Arm 110 may accommodate an Aperture 128′ for attaching a suspension cable or rope thereto. It will be appreciated that in some alternative exemplary embodiments, Aperture 128′ may be located in the region of overlap itself (not shown).

It will be appreciated by persons skilled in the art that the present invention is not limited by what has been particularly shown and described hereinabove. Rather the scope of the invention also includes variations and modifications that would occur to persons skilled in the art upon reading the foregoing description and which are not in the prior art.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A device comprising:
an angular body comprising a horizontal arm and a vertical arm configured for being positioned perpendicularly to one another and connected at an overlapping portion therebetween, wherein:
the horizontal arm comprising a horizontal engagement platform to be mounted on a top portion of a wall erected uprightly, the horizontal engagement platform extending along the horizontal arm from an end opposing the overlapping portion to a point spaced from the vertical arm, whereby a cavity between the horizontal arm and the top portion of the wall is formed;
the vertical arm comprising a vertical engagement platform to be adjoined to a front face portion of the wall;
the angular body further comprising an aperture adapted to accommodate a suspension cable;
and,
a width adjusting member capable of being fixated to the horizontal arm at one of a plurality of predetermined locations, the width adjusting member being further configured to accommodate a clamping member having an opposing engagement plate substantially parallel to the vertical engagement platform and adapted to be adjoined to a rear face portion of the wall, the opposing engagement plate being selectively movable towards and away from the rear face portion to allow for selective fastening and unfastening of the device to the wall.

2. The device of claim 1, wherein the aperture in the angular body is located at an upper portion of the vertical arm proximally to the overlapping portion.

3. The device of claim 1, wherein the aperture in the angular body is located at an end of the horizontal arm protruding beyond the overlapping portion.

4. The device of claim 1, wherein the aperture in the angular body is located at the overlapping portion.

5. The device of claim 1, wherein the width adjusting member is positioned in an angle of less than 90 degrees relatively to the horizontal arm.

6. The device of claim 1, wherein the width adjusting member further comprises a support member of a triangular shape configured for engagement with the horizontal engagement platform at a point where the width adjusting member is fixated to the horizontal arm.

7. The device of claim 1, wherein the horizontal arm comprises a plurality of apertures disposed along a longitudinal axis thereof and configured to accommodate a laterally inserted bolt, wherein the plurality of predetermined locations at which the width adjusting member is capable of being fixated to the horizontal arm are congruent with the positions of the plurality of apertures.

8. The device of claim 1, wherein the clamping member comprises a screwable threaded rod to which the opposing engagement plate is connected at one end and having a gripping handle provided at another end.

9. The device of claim 1, wherein the vertical engagement platform extending along the vertical arm from an end opposing the overlapping portion to a point spaced from the horizontal arm, whereby a cavity between the vertical arm and the front face portion of the wall is formed.

10. A device comprising:
an angular body comprising a horizontal arm and a vertical arm configured for being positioned perpendicularly to one another and connected at an overlapping portion therebetween, wherein:
the horizontal arm comprising a horizontal engagement platform to be mounted on a top portion of a wall erected uprightly;
the vertical arm comprising a vertical engagement platform to be adjoined to a front face portion of the wall, the vertical engagement platform extending along the vertical arm from an end opposing the overlapping portion to a point spaced from the horizontal arm, whereby a cavity between the vertical arm and the front face portion of the wall is formed;
the angular body further comprising an aperture adapted to accommodate a suspension cable;
and,
a width adjusting member capable of being fixated to the horizontal arm at one of a plurality of predetermined locations, the width adjusting member being further configured to accommodate a clamping member having an opposing engagement plate substantially parallel to the vertical engagement platform and adapted to be adjoined to a rear face portion of the wall, the opposing engagement plate being selectively movable towards and away from the rear face portion to allow for selective fastening and unfastening of the device to the wall.

11. The device of claim 10, wherein the aperture in the angular body is located at an upper portion of the vertical arm proximally to the overlapping portion.

12. The device of claim 10, wherein the aperture in the angular body is located at an end of the horizontal arm protruding beyond the overlapping portion.

13. The device of claim 10, wherein the aperture in the angular body is located at the overlapping portion.

14. The device of claim 10, wherein the width adjusting member is positioned in an angle of less than 90 degrees relatively to the horizontal arm.

15. The device of claim 10, wherein the width adjusting member further comprises a support member of a triangular shape configured for engagement with the horizontal engagement platform at a point where the width adjusting member is fixated to the horizontal arm.

16. The device of claim 10, wherein the horizontal arm comprises a plurality of apertures disposed along a longitudinal axis thereof and configured to accommodate a laterally inserted bolt, wherein the plurality of predetermined locations at which the width adjusting member is capable of being fixated to the horizontal arm are congruent with the positions of the plurality of apertures.

17. The device of claim 10, wherein the clamping member comprises a screwable threaded rod to which the opposing engagement plate is connected at one end and having a gripping handle provided at another end.
